(19) United States
(12) Patent Application Publication
(10) Pub. No.: US 2017/0264526 A1
(43) Pub. Date: Sep. 14, 2017

(54) INFORMATION COLLECTING APPARATUS, INFORMATION ANALYZING APPARATUS, AND INFORMATION TRANSFERRING METHOD BASED ON DIFFERENT INTERNET OF THINGS PLATFORMS

(71) Applicant: Electronics and Telecommunications Research Institute, Daejeon (KR)

(72) Inventors: Hyung Keuk LEE, Seoul (KR); Nam Kyung LEE, Daejeon (KR); Hyun Woo LEE, Seoul (KR)

(73) Assignee: Electronics and Telecommunications Research Institute, Daejeon (KR)

(21) Appl. No.: 15/452,038

(22) Filed: Mar. 7, 2017

(30) Foreign Application Priority Data
Mar. 9, 2016 (KR) 10-2016-0028414

(51) Int. Cl. H04L 12/26; H04W 4/00

(52) U.S. Cl. CPC H04L 43/18; H04W 4/006

(57) ABSTRACT

Provided are an information collecting apparatus, an information analyzing apparatus, and an information transferring method based on different Internet of things (IoT) platforms. The information collecting apparatus includes a reception unit configured to receive pieces of platform-based device generation information from IoT devices by platforms, a memory configured to store the received pieces of platform-based device generation information, and a transmission unit configured to simultaneously transmit the pieces of platform-based device generation information, stored in the memory, to an information analyzing apparatus.

### CROSS-REFERENCE TO RELATED APPLICATIONS

This application claims priority under 35 U.S.C. §119 to Korean Patent Application No. 10-2016-0028414, filed on Mar. 9, 2016, the disclosure of which is incorporated herein by reference in its entirety.

### TECHNICAL FIELD

The present invention relates to information managing and processing technology.

### BACKGROUND

Internet of things (IoT) has advanced from a wireless sensor network (WSN), a ubiquitous sensor network (USN), and machine to machine (hereinafter referred to as M2M). The M2M has the main purpose of performing communication between devices, but the IoT extends the fields of things and enables persons or things to communicate with various kinds of things (for example, smartphones, kettles, shoes, persons, etc.) which are commonly seen. That is, the IoT may be defined as a thing space connection network where an intelligent relationship, such as networking, information processing, etc., is provided through cooperation even without an explicit intervention of a person, for three distributed environment factors such as persons, things, and services.

Moreover, various concepts and technologies such as Web of things (WoT) are being researched for interoperation between various services and the Web. Due to the advance and expansion of the concepts and technologies, it is expected that the use of devices easily connectable to the Internet increases.

### SUMMARY

Accordingly, the present invention provides an information collecting apparatus, an information analyzing apparatus, and an information transferring method based on different IoT platforms, which efficiently manage and process massive information generated from an IoT-based device.

In one general aspect, an information collecting apparatus based on different Internet of things (IoT) platforms includes a reception unit configured to receive pieces of platform-based device generation information from IoT devices by platforms, a memory configured to store the received pieces of platform-based device generation information, and a transmission unit configured to simultaneously transmit the pieces of platform-based device generation information, stored in the memory, to an information analyzing apparatus.

Each of the platforms may be an access point platform, a hub platform, or a gateway platform.

The information collecting apparatus may further include a calculation unit configured to remove a temporal and spatial correlation between the pieces of platform-based device generation information and compress the pieces of platform-based device generation information. The calculation unit may include a transformation unit configured to signal-transform the pieces of platform-based device generation information to remove the temporal and spatial correlation. The calculation unit may include a compression sensing unit configured to multiply the pieces of platform-based device generation information by different sensing matrixes to reduce an amount of information of a device. The calculation unit may include a weight processing unit configured to allocate different weight values by platforms, based on significance of a device of each of the platforms, and allocate different weight values by devices, based on significance of device generation information in the same platforms.

In another general aspect, an information analyzing apparatus based on different Internet of things (IoT) platforms includes a restoration unit configured to decode pieces of information received from different platforms-based information collecting apparatuses to simultaneously restore pieces of device generation information of different platforms-based IoT devices and an analysis unit configured to analyze the restored pieces of device generation information.

The restoration unit may restore the pieces of information, received from the different platforms-based information collecting apparatuses, through compression sensing decoding. The restoration unit may decode the pieces of information received from the different platforms-based information collecting apparatuses, based on weight values allocated for each of different platforms or weight values allocated for each of devices in the same platforms, thereby restoring the pieces of device generation information by different platforms or by devices.

In another general aspect, an information transferring method based on different Internet of things (IoT) platforms includes receiving, by an information collecting apparatus based on different IoT platforms, pieces of platform-based device generation information from IoT devices by platforms and simultaneously transmitting the received pieces of platform-based device generation information to an information analyzing apparatus.

The transmitting of the received pieces of platform-based device generation information may include storing the pieces of platform-based device generation information during a certain time period and simultaneously transmitting the pieces of platform-based device generation information, stored during the certain time period, to the information analyzing apparatus.

The transmitting of the received pieces of platform-based device generation information may include signal-transforming the pieces of platform-based device generation information to remove a correlation, and transmitting pieces of platform-based device generation information, where the correlation has been removed, to the information analyzing apparatus.

The transmitting of the received pieces of platform-based device generation information may include multiplying the pieces of platform-based device generation information by different sensing matrixes to reduce an amount of information of a device, and transmitting pieces of platform-based device generation information, wherein the amount of information has been reduced, to the information analyzing apparatus.

The transmitting of the received pieces of platform-based device generation information may include allocating different weight values by platforms, based on significance of a device of each of the platforms or allocating different weight values by devices, based on significance of device generation information in the same platforms, and transmitting the pieces of platform-based device generation information to the information analyzing apparatus.

Other features and aspects will be apparent from the following detailed description, the drawings, and the claims.

### BRIEF DESCRIPTION OF THE DRAWINGS

FIG. 1 is a configuration diagram of an IoT system according to an embodiment of the present invention.

FIG. 2 is a configuration diagram of an IoT system for describing an example of compressing massive information by using a block-based compression sensing technique in an environment where devices based on different IoT platforms according to an embodiment of the present invention coexist.

FIG. 3 is a configuration diagram of an IoT system for describing an example of applying a weight value in a process of compressing information of a device based on different IoT platforms according to an embodiment of the present invention.

FIG. 4 is a block diagram of an information collecting apparatus according to an embodiment of the present invention.

FIG. 5 is a block diagram illustrating a detailed configuration of a calculation unit of FIG. 4 according to an embodiment of the present invention.

FIG. 6 is a block diagram illustrating a detailed configuration of an information analyzing apparatus according to an embodiment of the present invention.

FIG. 7 is a flowchart illustrating an information transferring method based on different IoT platforms according to an embodiment of the present invention.

FIG. 8 is a flowchart illustrating a detailed process of an arithmetic operation of FIG. 7 according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Like reference numerals refer to like elements throughout.

Detailed descriptions related to well-known functions or configurations will be ruled out in order not to unnecessarily obscure subject matters of the present invention. Moreover, the terms used henceforth have been defined in consideration of the functions of the present invention, and may be altered according to the intent of a user or operator, or conventional practice. Therefore, the terms should be defined on the basis of the entire content of this specification.

Combinations of each block of the accompanying block diagrams and each step of the accompanying flowcharts may be performed by instructions (execution engines) which are computer programs. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Hereinafter, exemplary embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to one of ordinary skill in the art.

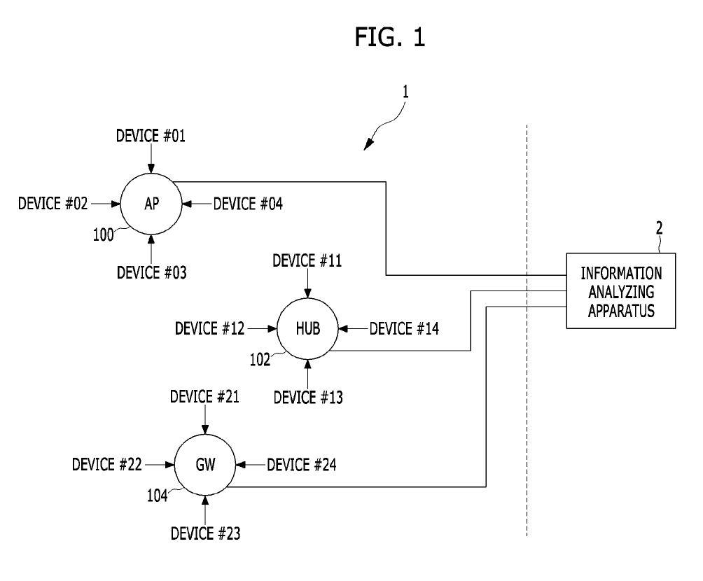

FIG. 1 is a configuration diagram of a different IoT system according to an embodiment of the present invention.

Referring to FIG. 1, the different IoT system may include an information collecting apparatus 1 and an information analyzing apparatus 2. Hereinafter, for convenience of description, IoT will be mainly described, but the IoT may replace or further include Web of thing (WoT) or Internet of everything (IoE).

The present invention relates to technology for efficiently managing and processing information of a device in a different IoT platform environment. The different IoT platform denotes that a platform corresponding to a device operating system (OS), a platform associated with information collected from devices, a platform for storing and analyzing collected information, and an application service-related platform differ.

There are countless various IoT device manufacturers, and moreover, there are various platforms and standards for operations of various IoT devices. Therefore, it is impossible to unify methods of managing and controlling devices. It can be predicted that in a space where IoT devices are used, various devices based on different platforms coexist rather than using only a single device provided by one manufacturer.

The present invention proposes technology for efficiently managing massive information which is explosively generated in a device cluster based on different IoT platforms and other manufacturer. Generally, massive data has a temporal or spatial correlation, and thus, by using such characteristic, the present invention may be applied to data compression. Therefore, the present invention proposes technology, which manages and processes massive data generated by devices under a condition where IoT devices manufactured based on various manufacturers and different platforms coexist, and technology for innovatively compressing massive information by using an intrinsic characteristic of data.

Hereinafter, each element having the above-described feature will be described with reference to FIG. 1.

A device may be an arbitrary object that is located in an end point, generates device information in real time, and transmits the device information. The device may be a home appliance, a sensor, or the like. The device may transmit information through a wireless or wired connection. Hereinafter, information generated by a device may be referred to as device generation information. The device generation information may be information representing a current state of a device. The current state information may be, for example, information about whether a device is turned on or off, opened or closed, idle or active, and/or available for task execution or busy. The device generation information may be a value sensed by a device. A device may be provided in plurality, and manufacturers of the plurality of devices may differ. For convenience of description, an IoT device will be mainly described, but a device may be a WoT device or an IoE device.

The information collecting apparatus 1, in an environment where various devices coexist, may primarily collect device generation information, process the collected device generation information, and transfer the processed device generation information to the information analyzing apparatus 2. The information collecting apparatus 1 may be provided in plurality, and platforms and standards for operations of the information collecting apparatuses 1 may differ. For example, as illustrated in FIG. 1, the information collecting apparatus 1 may be an access point (AP) 100, a hub 102, and a gateway (GW) 104 which are different platforms. The information collecting apparatus 1 may operate in different platforms which differ, and may collect information from different devices in the same platform.

The information analyzing apparatus 2 may receive the processed device generation information from the information collecting apparatus 1 and may restore the device generation information. The information analyzing apparatus 2 may be a fusion center, a management center, another type of AP or hub, a Web-based platform, and a cloud-based server.

Although devices based on different IoT platforms coexist variously and names of platforms differ, there is the information collecting apparatus 1 that primarily collects information generated by each device. The information collecting apparatus 1 may be the AP 100, the hub 102, and the GW 104. Various devices may be simultaneously used in an environment where different IoT platforms of the AP 100, the hub 102, and the GW 104 coexist.

The information collecting apparatus 1 may collect information from various devices. For example, as illustrated in FIG. 1, the AP 100 may collect information generated from devices #01 to #04, the hub 102 may collect information generated from devices #11 to #14, and the GW 104 may collect information generated from devices #21 to #24.

The information analyzing apparatus 2 of an end point which stores and analyzes information may be provided for using the device generation information, collected through the information collecting apparatus 1, as a better service. The information analyzing apparatus 2 may have various names by platforms. For example, the information analyzing apparatus 1 may be referred to as a fusion center, a management center, an AP (or a hub), a Web-based platform, a cloud-based server, etc. If the information collecting apparatus 1 is a primary collection point, the information analyzing apparatus 2 may be referred to as an end collection point.

The AP 100, the hub 102, and the GW 104 which each are the primary collection point may transfer the device generation information to the information analyzing apparatus 2 of the end point through a wireless or wired connection. Although there is a difference between characteristics of devices, pieces of information may be collected in real time by the AP 100, the hub 102, and the GW 104 which each are the primary collection point. However, the pieces of information may mainly have a temporal or spatial correlation therebetween. Therefore, the information collecting apparatus 1 may transform pieces of primarily collected information by reflecting the temporal or spatial correlation, and thus, may remove the temporal or spatial correlation, thereby reducing the amount of information. For example, the information collecting apparatus 1 may reduce the amount of information through Fourier Transform or Wavelet Transform.

Moreover, as described above, although the amount of information is reduced with respect to the information collecting apparatus 1 which is the primary collection point, if a plurality of different platforms coexist, the amount of information in the information analyzing apparatus 2 which is the end collection point may increase in proportion to the number of coexisting platforms. The information collecting apparatus 1 may compress information by using a block-based compression sensing technique, for reducing information.

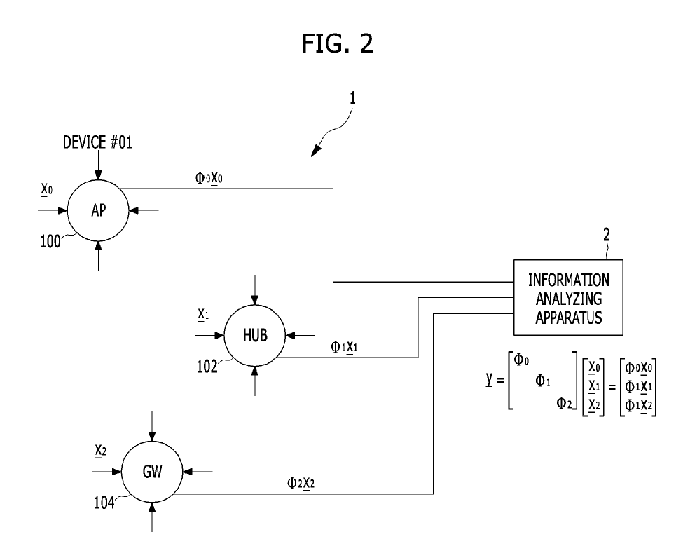

FIG. 2 is a configuration diagram of an IoT system for describing an example of compressing massive information by using a block-based compression sensing technique in an environment where devices based on different IoT platforms according to an embodiment of the present invention coexist.

Referring to FIGS. 1 and 2, the information collecting apparatus 1 may collect device generation information from a device based on different IoT platforms and may process and compress the collected device generation information. For example, the AP 100 which the primary collection point may collect pieces of device generation information from devices #1 to #4 connected to each other. The AP 100 may vectorize the collected pieces of device generation information, and then, in order to remove correlation information between the vectorized pieces of device generation information, the AP 100 may reduce the amount of information through transformation (for example, Fourier Transform or Wavelet Transform). Information “x₀” illustrated in FIG. 2 may be information itself collected through the AP 100, or may be information where the amount of information has been reduced through transformation.

Because of coexisting different IoT platforms, when information “x₁” collected by the hub 102 and information “x₂” collected by the GW 104, in addition to the information “x₀”, are collected in the information analyzing apparatus 2 (the end collection point) at a time, the collected information may be converted into massive data. Therefore, the information collecting apparatus 1 which is the primary collection point may reduce the amount of information of an end point through another processing. In this case, a sensing matrix based on the block-based compression sensing technique may be used. The sensing matrix may be differently set based on characteristics of the information collecting apparatuses 100, 102, and 104, a multiplication operation may be performed on device generation information, and information “Φ₀x₀” may be transferred to the information analyzing apparatus 2 of the end point (for example, by using a sensing matrix “Φ₀” in a case of the AP). In this case, the amount of information may be reduced according to the principle of compression sensing. Also, the information analyzing apparatus 2 of the end point may receive pieces of information (for example, y) transmitted based on different IoT platforms at a time and may completely restore information generated for each of devices based on different IoT platforms by using various compression sensing restoration algorithms (for example, IHT, CoSaMP, etc.).

To provide a more detailed description, the information collecting apparatus 1 may reduce the amount of information by performing transformation on information generated for each of different IoT platforms, based on a characteristic of a device and then, may transfer the information “Φ₀ x₀”, where the amount of information has been additionally reduced by using a sensing matrix for each platform, to the information analyzing apparatus 2 of the end point. In this case, since pieces of information are collected by using different sensing matrixes by different platforms, an error where different pieces of information are mixed does not occur. Also, by using a block-based compression sensing decoding technique, the information analyzing apparatus 2 may completely restore information generated for each device, based on the principle of compression sensing.

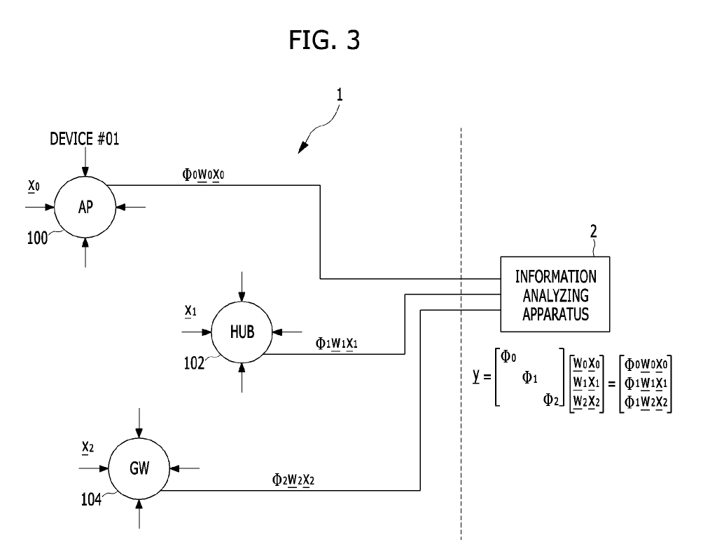

FIG. 3 is a configuration diagram of an IoT system for describing an example of applying a weight value in a process of compressing information of a device based on different IoT platforms according to an embodiment of the present invention.

Referring to FIG. 3, in a process where the device based on different IoT platforms according to an embodiment of the present invention processes and compresses generation information, a weight value may be applied based on significance between different IoT platforms. For example, if information of an IoT platform including a wellness device and information of an IoT platform including a temperature, humidity, and an illuminance are simultaneously stored, information of a platform that manages the wellness device may be information having high significance. In order to reflect such a condition, before performing an arithmetic operation based on a sensing matrix, information “x₀” may be multiplied by a weight value “w₀” representing significance of a platform, and then, may be again multiplied by the sensing matrix. For example, if the information “x₀” includes details which are more significant than information “x₁”, the weight value “w₀” may have a value which is greater than that of weight value “w₁”.

Furthermore, in a device managing more significant information in the same platforms, values of elements of the weight value “w₀” may be differently set. Even when information obtained through transformation and compression is transferred to the information analyzing apparatus 2 which is the end collection point, information generated for each of devices based on different IoT platforms may be completely restored by using various compression sensing restoration algorithms known to those skilled in the art.

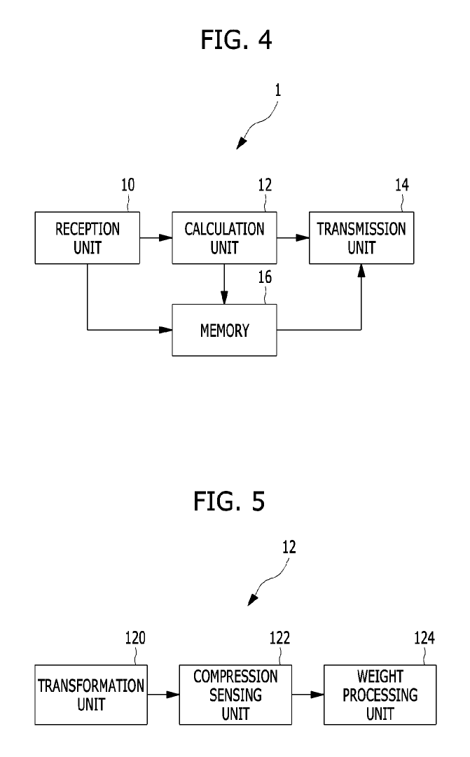

FIG. 4 is a block diagram of an information collecting apparatus 1 according to an embodiment of the present invention.

Referring to FIG. 4, the information collecting apparatus 1 may include a reception unit 10, a transmission unit 14, and a memory 16 and may further include a calculation unit 12.

The reception unit 10 may receive pieces of device generation information from IoT devices by platforms. In this case, each of the platforms may be located in a device generation information collection point, and for example, may be an AP, a hub, or a GW. The memory 16 may store information, generated by performing an operation of the information collecting apparatus 1, and information necessary for performing the operation. The memory 16 according to an embodiment may store pieces of device generation information received from devices for each platform. The transmission unit 14 may simultaneously transmit the pieces of device generation information by platforms, stored in the memory 16, to an information analyzing apparatus. The calculation unit 12 may remove a temporal and spatial correlation between the pieces of device generation information by platforms and may compress the pieces of device generation information. A detailed configuration of the calculation unit 12 will be described below with reference to FIG. 5.

FIG. 5 is a block diagram illustrating a detailed configuration of the calculation unit 14 of FIG. 4 according to an embodiment of the present invention.

Referring to FIG. 5, the calculation unit 14 may include a transformation unit 120, a compression sensing unit 122, and a weight processing unit 124.

The transformation unit 120 may signal-transform pieces of platform-based device generation information to remove a correlation. For example, the transformation unit 120 may perform Fourier Transform, Wavelet Transform, or the like. The compression sensing unit 122 may perform a multiplication operation on pieces of platform-based device generation information obtained through the transformation by the transformation unit 120 by using different sensing matrixes to reduce the amount of information of a device.

The weight processing unit 124 may allocate different weight values with respect to the pieces of platform-based device generation information for which compression sensing has been performed by the compression sensing unit 122. For example, the weight processing unit 124 may allocate different weight values by platforms, based on significance of a device of each platform. As another example, the weight processing unit 124 may allocate different weight values by devices, based on significance of device generation information in the same platforms.

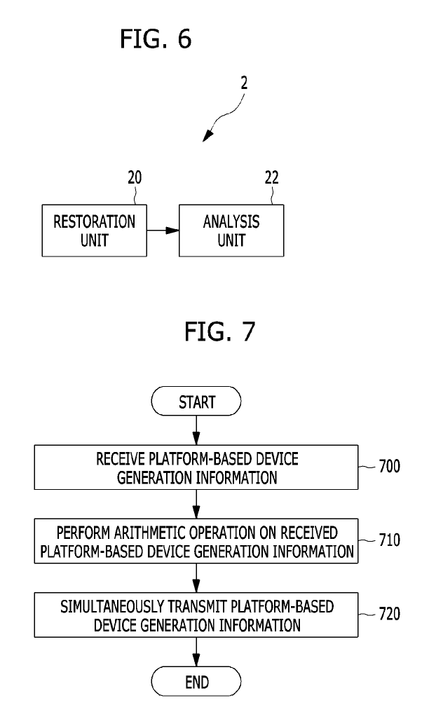

FIG. 6 is a block diagram illustrating a detailed configuration of an information analyzing apparatus 2 according to an embodiment of the present invention.

Referring to FIG. 6, the information analyzing apparatus 2 may include a restoration unit 20 and an analysis unit 22.

The restoration unit 20 may decode pieces of information received from information collecting apparatuses by different platforms and may simultaneously restore pieces of device generation information of IoT devices by different platforms. The analysis unit 22 may analyze the restored pieces of device generation information.

The restoration unit 20 according to an embodiment may restore information, received from each of information collecting apparatuses, through compression sensing decoding. The restoration unit 20 according to an embodiment may reflect a weight value to restore the information. For example, the restoration unit 20 may decode the information received from each information collecting apparatus, based on a weigh value allocated for each of different platforms or a weight value allocated for each device in the same platforms.

FIG. 7 is a flowchart illustrating an information transferring method based on different IoT platforms according to an embodiment of the present invention.

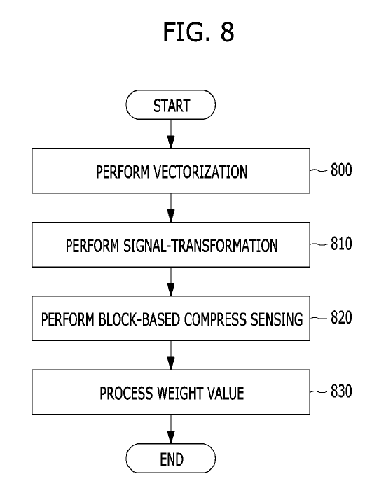

Referring to FIG. 7, the information collecting apparatus 1 such as the AP 100, the hub 102, or the GW 104 may receive pieces of device generation information from devices by platforms in step 700. Subsequently, in step 710, the information collecting apparatus 1 may perform an arithmetic operation on the received pieces of device generation information to reduce the amount of data. A calculation process (710) will be described below with reference to FIG. 8.

Subsequently, in step 720, the information collecting apparatus 1 may simultaneously transmit the pieces of device generation information, for which the arithmetic operation has been performed, to the information analyzing apparatus 2 through a wireless or wired connection. To this end, the information collecting apparatus 1 may store pieces of platform-based device generation information during a certain time period, and then, may simultaneously transmit the pieces of platform-based device generation information. Subsequently, the information analyzing apparatus 2 may restore device generation information from information received from the information collecting apparatus 1.

FIG. 8 is a flowchart illustrating a detailed process of the arithmetic operation of FIG. 7 according to an embodiment of the present invention.

Referring to FIG. 8, in step 800, the information collecting apparatus 1 may vectorize pieces of device generation information. Subsequently, in step 810, the information collecting apparatus 1 may reduce the amount of information by performing Fourier Transform or Wavelet Transform for removing correlation information between the vectorized pieces of device generation information. Also, in step 820, the information collecting apparatus 1 may multiply the pieces of device generation information by a sensing matrix specialized for each platform by using the block-based compression sensing technique. Subsequently, in step 830, the information collecting apparatus 1 may allocate different weight values by platforms, based on significance of a device of each platform, or may allocate different weight values by devices, based on significance of device generation information in the same platforms.

According to the embodiments of the present invention, IoT device, WoT devices, and IoE devices provided by various manufacturers and various platforms may be used simultaneously, and massive information of a device which is generated in real time may be simultaneously and robustly transferred to an information analyzing apparatus of an end point.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An information collecting apparatus based on different Internet of things (IoT) platforms, the information collecting apparatus comprising:
a reception unit configured to receive pieces of platform-based device generation information from IoT devices by platforms;
a memory configured to store the received pieces of platform-based device generation information; and
a transmission unit configured to simultaneously transmit the pieces of platform-based device generation information, stored in the memory, to an information analyzing apparatus.

2. The information collecting apparatus of claim 1, wherein each of the platforms is an access point platform, a hub platform, or a gateway platform.

3. The information collecting apparatus of claim 1, further comprising: a calculation unit configured to remove a temporal and spatial correlation between the pieces of platform-based device generation information and compress the pieces of platform-based device generation information.

4. The information collecting apparatus of claim 3, wherein the calculation unit comprises a transformation unit configured to signal-transform the pieces of platform-based device generation information to remove the temporal and spatial correlation.

5. The information collecting apparatus of claim 3, wherein the calculation unit comprises a compression sensing unit configured to multiply the pieces of platform-based device generation information by different sensing matrixes to reduce an amount of information of a device.

6. The information collecting apparatus of claim 3, wherein the calculation unit comprises a weight processing unit configured to allocate different weight values by platforms, based on significance of a device of each of the platforms, and allocate different weight values by devices, based on significance of device generation information in the same platforms.

7. An information analyzing apparatus based on different Internet of things (IoT) platforms, the information analyzing apparatus comprising:
a restoration unit configured to decode pieces of information received from different platforms-based information collecting apparatuses to simultaneously restore pieces of device generation information of different platforms-based IoT devices; and
an analysis unit configured to analyze the restored pieces of device generation information.

8. The information analyzing apparatus of claim 7, wherein the restoration unit restores the pieces of information, received from the different platforms-based information collecting apparatuses, through compression sensing decoding.

9. The information analyzing apparatus of claim 7, wherein the restoration unit decodes the pieces of information received from the different platforms-based information collecting apparatuses, based on weight values allocated for each of different platforms or weight values allocated for each of devices in the same platforms, thereby restoring the pieces of device generation information by different platforms or by devices.

10. An information transferring method based on different Internet of things (IoT) platforms, the information transferring method comprising:
receiving, by an information collecting apparatus based on different IoT platforms, pieces of platform-based device generation information from IoT devices by platforms; and
simultaneously transmitting the received pieces of platform-based device generation information to an information analyzing apparatus.

11. The information transferring method of claim 10, wherein the transmitting of the received pieces of platform-based device generation information comprises:
storing the pieces of platform-based device generation information during a certain time period; and
simultaneously transmitting the pieces of platform-based device generation information, stored during the certain time period, to the information analyzing apparatus.

12. The information transferring method of claim 10, wherein the transmitting of the received pieces of platform-based device generation information comprises signal-transforming the pieces of platform-based device generation information to remove a correlation, and transmitting pieces of platform-based device generation information, where the correlation has been removed, to the information analyzing apparatus.

13. The information transferring method of claim 10, wherein the transmitting of the received pieces of platform-based device generation information comprises multiplying the pieces of platform-based device generation information by different sensing matrixes to reduce an amount of information of a device, and transmitting pieces of platform-based device generation information, wherein the amount of information has been reduced, to the information analyzing apparatus.

14. The information transferring method of claim 10, wherein the transmitting of the received pieces of platform-based device generation information comprises allocating different weight values by platforms, based on significance of a device of each of the platforms or allocating different weight values by devices, based on significance of device generation information in the same platforms, and transmitting the pieces of platform-based device generation information to the information analyzing apparatus.
